(19) United States
(12) Patent Application Publication
(10) Pub. No.: US 2020/0373664 A1
(43) Pub. Date: Nov. 26, 2020

(54) CONFIGURABLE MULTIBAND ANTENNA ARRANGEMENT WITH A MULTIELEMENT STRUCTURE AND DESIGN METHOD THEREOF

(71) Applicant: INSTITUT MINES TELECOM - IMT ATLANTIQUE - BRETAGNE - PAYS DE LA LOIRE, Brest Cedex 3 (FR)

(72) Inventor: Jean-Philippe COUPEZ, Brest (FR)

(21) Appl. No.: 16/771,209

(22) PCT Filed: Dec. 17, 2018
(86) PCT No.: PCT/EP2018/085282

§ 371 Date: Jun. 9, 2020

(30) Foreign Application Priority Data
Dec. 22, 2017 (EP) 17306929.5

(51) Int. Cl. H01Q 5/25; H01Q 1/36; H01Q 5/371; H01Q 9/42

(52) U.S. Cl. CPC H01Q 5/25; H01Q 9/42; H01Q 5/371; H01Q 1/36

(57) ABSTRACT

A multiband antenna arrangement includes at least two main conductive elements, the first main conducting element resonating at a first fundamental mode of a first electromagnetic radiation and the second main conducting element resonating at a second fundamental mode of a second electromagnetic radiation, wherein the second main conductive element is connected to the first main conductive element at a feed connection located at a position defined as a function of bellies of current of the first electromagnetic radiation and the antenna arrangement has more resonating modes than the first main conductive element. The antenna arrangement may also be configured so that some of the resonating modes of the first main conductive element have a bandwidth that is enlarged in comparison to the corresponding bandwidth of these resonating modes for the first main conductive element. A design method of the antenna arrangement to provide a match between the resonating modes of the antenna arrangement and a specification defined by a list of frequencies and, possibly, corresponding bandwidths at a predefined matching level and selectivity, as well, as in certain embodiments, a predefined form factor.

### FIELD OF THE INVENTION

The invention relates to antenna arrangements having a plurality of frequency modes in the VHF, UHF, L, S, C, X or higher frequency bands. More precisely, an antenna arrangement according to the invention may be designed and tuned in a simple manner to transmit/receive (T/R) radiofrequency signals at a plurality of predetermined frequencies, notably in the microwave or VHF/UHF domains, with compact form factors.

### BACKGROUND

There is now a need to connect terminals or smartphones on board aircraft, ships, trains, trucks, cars, or carried by pedestrians, while on the move. All kinds of objects on board vehicles or located in a manufacturing plant, an office, a warehouse, a storage facility, retail establishments, hospitals, sporting venues, or a home are connected to the Internet of Things (IoT): tags to locate and identify objects in an inventory or to keep people in or out of a restricted area; devices to monitor physical activity or health parameters of their users; sensors to capture environmental parameters (concentration of pollutants; hygrometry; wind speed, etc.); actuators to remotely control and command all kinds of appliances, or more generally, any type of electronic device that could be part of a command, control, communication and intelligence system, the system being for instance programmed to capture/process signals/data, transmit the same to another electronic device, or a server, process the data using processing logic implementing artificial intelligence or knowledge based reasoning and return information or activate commands to be implemented by actuators.

Radio Frequency (RF) communications are more versatile than fixed-line communications for connecting these types of objects or platforms. As a consequence, radiofrequency T/R modules are and will be more and more pervasive in professional and consumer applications. A plurality of T/R modules may be implemented on the same device. By way of example, a smartphone typically includes a cellular communications T/R module, a Wi-Fi/Bluetooth T/R module, a receiver of satellite positioning signals (from a Global Navigation Satellite System or GNSS). Wi-Fi, Bluetooth and 3G or 4G cellular communications are in the 2.5 GHz frequency band (S-band). GNSS receivers typically operate in the 1,5 GHz frequency band (L-band). Radio Frequency IDentification (RFID) tags operate in the 900 MHz frequency band (UHF) or lower. Near Field Communication (NFC) tags operate in the 13 MHz frequency band (HF) at a very short distance (about 10 cm).

It seems that a good compromise for IoT connections lies in VHF or UHF bands (30 to 300 MHz and 300 MHz to 3 GHz) to get sufficient available bandwidth and range, a good resilience to multipath reflections as well as a low power budget.

A problem to be solved for the design of T/R modules at these frequency bands is to have antennas which are compact enough to fit in the form factor of a connected object.

A traditional omnidirectional antenna of a monopole type, adapted for VHF bands, has a length between 25 cm and 2.5 m (2/4).

A solution to this problem is notably provided by PCT application published under n° WO2015007746, which has the same inventor and is co-assigned to the applicant of this application. This application discloses an antenna arrangement of a bung type, where a plurality of antenna elements are combined so that the ratio between the largest dimension of the arrangement and the wavelength may be much lower than a tenth of a wavelength, even lower than a twentieth or, in some embodiments than a fiftieth of a wavelength. To achieve such a result, the antenna element, which controls the fundamental mode of the antenna, is wound up in a 3D form factor, such as, for example, a helicoid, so that its outside dimensions are reduced relative to its length.

But there is also a need for the connected devices to be compatible with terminals communicating using Wi-Fi and/or Bluetooth frequency bands and protocols. In this use case, some stages of the T/R module have to be compatible with both VHF and S bands. If a GNSS receiver is added to such device, a T/R capacity in L band is also needed. This means that the antenna arrangements of such devices should be able to communicate simultaneously or successively in different frequency bands. Adding as many antennas as frequency bands is costly in terms of form factor, power budget and materials. This creates another challenging problem for the design of the antenna. Some potential solutions are disclosed for base station antennas by PCT applications published under n° WO200122528 and WO200334544. But these solutions do not operate in VHF bands and do not provide arrangements which would be compact enough in these bands.

The applicant of this application has filed a European patent application under n° EP2016/306059.3 that has the same inventor as this application. This application discloses a “bonsai” antenna arrangement, i.e. an antenna arrangement comprising: a first conductive element configured to radiate above a defined frequency of electromagnetic radiation; one or more additional (or secondary) conductive elements located at or near one or more positions defined as a function of positions of nodes of current (i.e. zero current or Open Circuit—OC—positions) of harmonics of the electromagnetic radiation.

The bonsai antenna arrangement disclosed by this patent application provides flexibility to adjust the radiating frequencies of the antenna around the higher order modes of the “trunk” antenna thanks to “leaves” that are placed by the designer of the antenna arrangement at selected spots on the trunk. But this flexibility is constrained in certain limits. Notably, the number of frequencies that may be adjusted on a same trunk should in practice be limited to four (fundamental mode plus the three first higher order modes) to avoid electromagnetic coupling between the leaves added to the trunk. Also, the length of the leaves should remain a fraction of the length of the trunk to avoid perturbing the other modes, so that the shift in frequency is limited to a fraction of the value of the radiating frequency of each mode. Therefore, it is not possible to implement easily any kind of selected frequencies on an antenna arrangement of the type disclosed by this above listed patent application.

The instant patent application overcomes these limitations to a significant extent.

### SUMMARY OF THE INVENTION

The invention fulfils this need by providing an antenna arrangement comprising a first main conductive element with a first fundamental mode and corresponding first higher order modes and at least a second main conductive element with a second fundamental mode and corresponding second higher order modes, the second main conductive element having a feed connection located at, or close to, a belly of current (also designated as a peak, i.e. a maximum of current or Short Circuit position, or SC position) of the first main conductive element, the antenna arrangement having a number of resonating modes that are higher than the number of resonating modes of the first main conductive element.

More specifically, the invention discloses an antenna arrangement comprising: a first main conductive element configured to resonate above a first frequency defining a first fundamental mode of a first electromagnetic radiation; at least a second main conductive element configured to radiate above a second frequency defining a second fundamental mode of a second electromagnetic radiation, and having a feed connection located at or near a position on the first main conductive element that is defined as a function of positions of bellies of current of harmonics of the first electromagnetic radiation, wherein the antenna arrangement has a number of resonating modes that are higher than a number of resonating modes of the first main conductive element.

Advantageously, the feed connection of the second main conductive element is located at a feed line of the first main conductive element.

Advantageously, at least a difference between a second given frequency of one of a fundamental mode or a higher order mode of the second electromagnetic radiation and a first given frequency of one of a fundamental mode or a higher order mode of the first electromagnetic radiation is higher than half the sum of the electromagnetic sensitivities of the second and first main conductive elements respectively at the second and first given frequencies, said electromagnetic sensitivities being defined at a given matching level.

Advantageously, the antenna arrangement of the invention, further comprises one or more first secondary conductive elements located at or near one or more positions defined on the first main conductive element as a function of positions of nodes of current of electromagnetic radiation of selected resonating modes of the first frequency.

Advantageously, the at least second main conductive element comprises one or more second secondary conductive elements located at or near one or more positions defined on the second main conductive element as a function of positions of nodes of current of selected resonating modes of the second frequency.

Advantageously, the second frequency is defined as having at least a resonating mode at which the second main conductive element forms a resonating structure of an order higher than one with parts of the antenna arrangement at a frequency of one of the selected resonating modes of the first frequency.

Advantageously, the resonating structure of an order higher than one is matched at or above a predefined level across a bandwidth defined around the frequency of the one of the selected resonating modes of the first frequency.

Advantageously, the bandwidth is equal to or larger than a predefined percentage value of the frequency of the one of the selected resonating modes of the first frequency.

Advantageously, the antenna arrangement is matched across the bandwidth surrounding the frequency of the one of the selected resonating modes of the first frequency at a level equal to or greater than an absolute predefined value.

Advantageously, the antenna arrangement of the invention further comprises at least a third main conductive element having a feed connection located at or near a position on one of the first or second main conductive elements that is defined as a function of positions of bellies of current of selected resonating modes of the first or second frequencies, said third main conductive element being configured to form with at least parts of the antenna arrangement a resonating structure of an order higher than one at a frequency of one of the selected resonating modes of the first or second frequencies.

Advantageously, one or more of the main conductive elements are a metallic ribbon and/or a metallic wire.

Advantageously, one or more of the main conductive elements have one of a 2D or 3D compact form factor.

Advantageously, the antenna arrangement of the invention is deposited by a metallization process on a non-conductive substrate layered with one of a polymer, a ceramic or a paper substrate.

Advantageously, the antenna arrangement of the invention is tuned to radiate in two or more frequency bands, comprising one or more of an ISM band, a Wi-Fi band, a Bluetooth band, a 3G band, a LTE band, a GNSS band or a 5G band.

The invention further discloses a method of designing an antenna arrangement comprising: defining a geometry of a first main conductive element to resonate above a first frequency defining a first fundamental mode of a first electromagnetic radiation; defining a geometry of a second main conductive element to resonate above a second frequency defining a second fundamental mode of a second electromagnetic radiation; forming a feed connection of the at least a second main conductive element located at or near a position on the first main conductive element that is defined as a function of positions of bellies of current of harmonics of the first electromagnetic radiation; wherein the antenna arrangement has a number of resonating modes that is higher than a number of resonating modes of the first main conductive element.

Advantageously, one or more main conductive elements of a defined length are iteratively added at defined positions to a pre-designed main conductive element so as to match a specification of the antenna arrangement comprising a list of predefined frequencies.

Advantageously, the one or more main conductive elements that are added to match the specification of the antenna arrangement are further defined to match a specified bandwidth for at least one or more of the frequencies in the list of frequencies.

Advantageously, the one or more main conductive elements that are added to match a specification are further defined to match a form factor of the antenna arrangement.

The multi-frequency antenna arrangement of the invention may be compact, allowing it to advantageously be integrated in small volumes.

The antenna arrangement of the invention is also advantageously simple to design, notably when tuning at least two radiating frequencies, but possibly more, to desired values, taking into account the impact of the environment of the antenna arrangement, notably the ground plane, the relative positioning of the first and second main conductive elements and of secondary conductive elements (or “leaves”) that have an electromagnetic impact on its electrical performance.

The antenna arrangement of the invention is easy to manufacture and has as a consequence a low production cost.

Also, the antenna arrangement of the invention is very easy to connect either in an orthogonal configuration or in a coplanar configuration to a RF Printed Circuit Board (PCB).

In some optional embodiments, the bandwidths of a fundamental radiating frequency or of higher order modes may be controlled, taking into account a target matching level, so as to guarantee a minimum quality of service at these controlled frequencies, when transmitting video or other content that need a high throughput.

### BRIEF DESCRIPTION OF THE DRAWINGS

The invention and its advantages will be better understood upon reading the following detailed description of particular embodiments, given purely by way of non-limiting examples, this description being made with reference to the accompanying drawings in which:

FIG. 1 represents an antenna arrangement according to the prior art;

FIG. 2 displays a prototype of an antenna arrangement according to an embodiment of the invention;

FIG. 3 illustrates the frequency responses of the antenna arrangement of FIG. 1 and of the antenna arrangement of FIG. 2;

FIG. 4 represents a first variant of an antenna arrangement with three trunks in an embodiment of the invention;

FIG. 5 illustrates the experimental frequency response of the antenna arrangement of FIG. 4;

FIG. 6 represents a second variant of an antenna arrangement with three trunks in an embodiment of the invention;

FIGS. 7a, 7b and 7c represent the individual frequency responses of each of the three trunks of the antenna arrangement of FIG. 6, while FIG. 7d represents the overall frequency response of the same antenna arrangement;

FIGS. 8a, 8b and 8c represent the individual frequency responses of three trunks of an antenna arrangement that have resonating frequencies that have lo been shifted relative to those of the antenna arrangement of FIG. 6, while FIG. 8d represents the overall frequency response of the combination of the three trunks;

FIG. 9a illustrates the calculation of the selectivity of a resonating structure at a given frequency and a given matching level, while FIG. 9b illustrates a combination of two frequency responses where the two resonating frequencies remain separate and FIG. 9c illustrates a combination of two frequency responses where the two resonating frequencies merge in an enlarged bandwidth;

FIGS. 10a and 10b respectively illustrate an antenna arrangement with a trunk and a branch with position and dimension parameters and a Smith Chart that allows direct calculation of the values characterizing the radiating behaviour of the antenna arrangement as a function of the position and dimension parameters;

FIGS. 11a and 11b respectively illustrate a first antenna arrangement with a trunk and two branches connected to the trunk and a second antenna arrangement with a trunk, a first branch connected to the trunk and a second branch connected to the first branch, both arrangements with their position and dimension parameters;

FIGS. 12a, 12b, 12c, 12d and 12e represent different embodiments of antenna arrangements according to the invention;

FIGS. 13a and 13b respectively represent a trunk antenna according to the prior art and its frequency response;

FIGS. 14a, 14b, 14c and 14d, respectively, represent a schematic of an antenna arrangement having a trunk and a branch with their position and dimension parameters, a Smith Chart for a first resonating frequency of the antenna, a Smith Chart for a second resonating frequency of the arrangement and the frequency responses of the trunk and the trunk with branch;

FIGS. 15a and 15b respectively represent a schematic of an antenna arrangement having a trunk and a branch position at the feed connection with their dimension parameters and the frequency response of the antenna arrangement;

FIG. 16 represents a flow chart of a method to design multiband antenna arrangements according to the invention;

FIGS. 17a and 17b respectively represent an example of a 2D antenna arrangement and its frequency response according to the prior art;

FIGS. 18a and 18b respectively represent another example of a 2D antenna arrangement and its frequency response according to the prior art;

FIGS. 19a and 19b respectively represent an example of a 2D multiband antenna arrangement according to the invention and its frequency response;

FIGS. 20a and 20b respectively represent another example of a 2D multiband antenna arrangement according to the invention and its frequency response.

### DETAILED DESCRIPTION

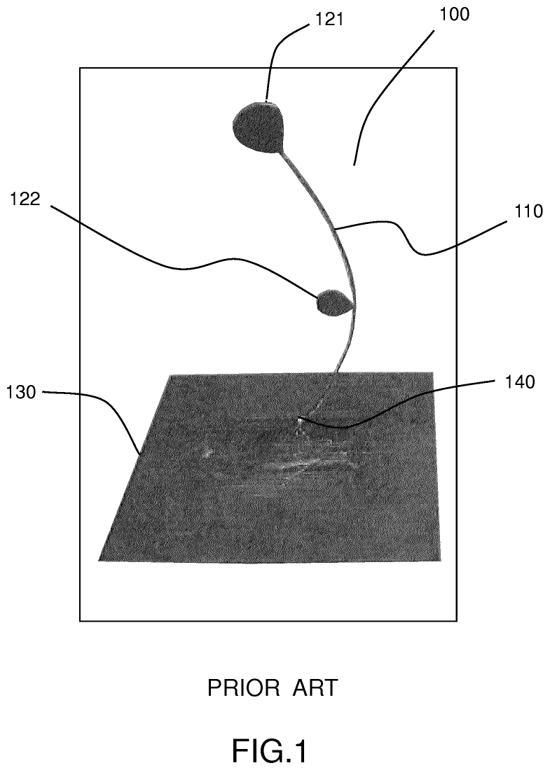

FIG. 1 represents an antenna arrangement according to the prior art.

The antenna arrangement 100 is a monopole antenna with an omnidirectional radiating pattern in the azimuth plane.

The structure of the antenna arrangement 100 according to embodiments disclosed in European patent application published under reference number EP2016/306059.3 is analogous to a compact tree structure that in some aspects resembles the structure of a bonsai. The dimensions of this arrangement are selected so that the antenna is fit to operate in the ISM (Industrial, Scientific and Medical), VHF and UHF bands. The tree comprises a trunk 110, leaves 121, 122. The tree is planted on a ground plane 130.

The trunk 110 is formed of a conductive material, metallic wire or ribbon, with a deployed physical length [symbol] which is defined as a function of the desired radiating frequency of the fundamental mode as explained further down in the description. The trunk may be inscribed in a plane. In some embodiments, the plane in which the trunk is inscribed may be parallel to the ground plane, or may be inscribed in the ground plane in a solution where the antenna and the ground plane are designed as a coplanar arrangement. In such an arrangement, the antenna may be engraved on a face of the substrate and the ground plane may be engraved on the backplane of the substrate. In other embodiments like the one depicted on FIG. 1, the plane in which the trunk is inscribed is perpendicular to the ground plane. The trunk may alternatively be inscribed in a non-planar surface or a volume structure. Such a form factor is advantageous to increase the compactness of an antenna arrangement of a given physical length [symbol] .

At this step, it is useful to introduce the notion of “electrical length” of a radiating element. The electrical length [symbol] _{e(λ)} of an element of physical length [symbol] at a wavelength λ is defined as [symbol] _{e(λ)}= [symbol] . Then, if the radiation propagates in a media of electromagnetic permittivity εᵣ, where λ=c/f\sqrt{εᵣ}, we will have [symbol] _{e(λ)}= [symbol] . In air, where εᵣ=1, we then have [symbol] _{e(λ)}= [symbol] ×f/c.

It is possible to express an electrical length in degrees or in radians. For instance, for [symbol] _{e(λ)}=1/4 (in λ unit), we can express this value as [symbol] _{e(°)}=90 (in units of degrees) or [symbol] _{e(rad)}=π/2 (in units of radians).

It is also possible to define an equivalent electrical length [symbol] _{e(λ)eq}. For instance, if a leaf of defined length and form factor is added on a trunk at a defined position with a defined orientation, the combination of the trunk and the leaf will have an equivalent electrical length defined as [symbol] _{e(λ)eq}= [symbol] +Δ [symbol] _{e(λ)}(f), where Δ [symbol] _{e(λ)}(f), that is a function of frequency f, and is a variation of the electrical length of the trunk that is a consequence of the addition of the leaf.

The leaves 121, 122 are also formed of a metal and mechanically and electrically connected to the trunk at defined points, as discussed further down in the description. The leaves may be seen as structures extending the length of the antenna of a defined amount in defined directions. The leaves may thus have different positions, form factors, dimensions and orientations in space. They may be inscribed together in a same plane or different surfaces or not. They may be inscribed in a plane that includes the trunk or not. The selected positions, form factors, dimensions and orientations will affect the variation in radiating frequencies (i.e. fundamental and higher order modes) imparted to the base frequencies defined by the length of the trunk.

The different radiating modes are basically defined by the electrical length of the radiating pole element:
The fundamental mode is defined by an electrical length [symbol] _{e(λ)} of the radiating element which is equal to 1/4(λ) (first harmonic) where λ=c/f, f being the radiating frequency at the fundamental mode;
The 1^{st} higher order mode is defined by an electrical length [symbol] _{e(λ}_{₁}₎ of the radiating element which is equal to 3/4(λ₁) (third harmonic) where λ₁=c/f₁, f₁ being the resonating frequency of the first higher order mode of the radiating element;
The 2^{nd} higher order mode is defined by an electrical length [symbol] _{e(λ}_{₂}₎ of the radiating element which is equal to 5/4(λ₂) (fifth harmonic) where λ₂=c/f₂, f₂ being the resonating frequency of the second higher order mode of the radiating element;
The 3^{rd} higher order mode is defined by an electrical length [symbol] _{e(λ}_{₃}₎ of the radiating element which is equal to 7/4(λ₃) (seventh harmonic) where λ₃=c/f₃, f₃ being the resonating frequency of the third higher order mode of the radiating element.

The ground plane 130 is the metallic backplane of a PCB structure, which comprises the excitation circuits which feed the RF signal to the trunk at their point of mechanical and electrical connection 140.

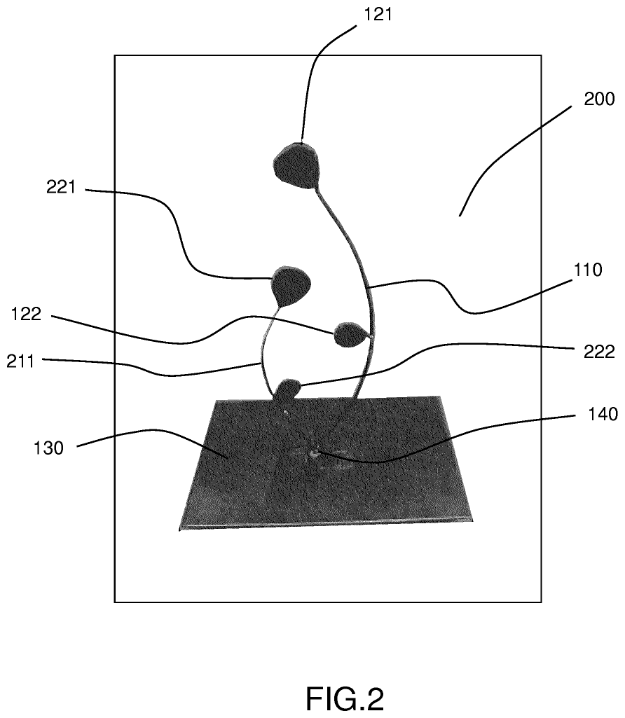

FIG. 2 displays a prototype of an antenna arrangement according to an embodiment of the invention.

The inventor of the antenna arrangement disclosed by European patent application filed under reference EP2016/306768.9 has discovered that adding branches of a predetermined length to the trunk of the bonsai at selected spots allowed adjusting the frequency bandwidths around the defined frequency of electromagnetic radiation of the antenna or its harmonics so as to be able to ensure a defined throughput, or to meet the performance requirements of various standards for radio-communication such as IEEE 802.11, 802.15.4 etc., for instance for transmitting multimedia contents with a defined quality of service. Such an antenna arrangement may achieve a controlled wideband capacity.

According to the instant invention, adding a branch (that may also be designated as a second “trunk”, when connected to the first trunk at the feed line of the antenna arrangement 140) of a defined length at a defined position offers other useful advantages.

The antenna arrangement 200 of FIG. 2 may be designed starting from the antenna arrangement 100 of FIG. 1, with its trunk 110 connected to the feed line 140 at the ground plane 130. The first trunk is a monopole antenna. The first trunk bears two leaves 121, 122 thus defining a multi-resonator at a plurality of frequencies fⱼ⁽ⁱ⁾ (the exponent (i) designating the index of the trunk or branch—where a trunk is connected to the feed line 140 and a branch is connected to another location that is different from the feed line 140—and the index j designating the order of the mode, no index designating the fundamental mode) that are defined starting by the fundamental mode f⁽¹⁾ so that the total electrical length of the trunk, including its leaves, equals one quarter of the wavelength at this frequency. According to the disclosure of EP2016/306059.3, the leaves 121, 122 are positioned at “Hot Spots” (or Open Circuit positions) along the trunk, the Hot Spots being defined at locations on the radiating pole where the electric current in the pole is minimal or the voltage is maximal. Adding a leaf at one of the Hot Spots for a mode (fundamental or higher order) shifts the radiating frequency to a lower value for this mode. Thus, the frequencies of the fundamental and higher order modes that are in a mathematical relationship explained above may be used to create radiating frequencies of a desired value.

According to an aspect of the invention, a second trunk 211 (or second main conductive element, the first trunk being defined as the first main conductive element) is added to the first trunk at position 140 which is a “Cold Spot” for all modes (Short Circuit position). Conversely to Hot Spots, Cold Spots are defined by the disclosure of EP2016/306059.3 as locations on the radiating pole where the electric current in the pole is maximal or the voltage is minimal. Adding a radiating element at a Cold Spot will not modify the radiating properties of the first trunk. Two leaves 221 and 222 are added to the second trunk 211. The total electrical length of the branch 211 plus the leaves 221 and 222 is set at [symbol] ⁽²⁾_{e(λ}_{⁽²⁾}₎=1/4(λ⁽²⁾) where λ⁽²⁾=c/f⁽²⁾ where the frequency f⁽²⁾ of the fundamental radiating mode of this combined element is determined according to a specification of the antenna arrangement.

According to this aspect of the invention, it will be possible to tune in the antenna arrangement comprising the first main conductive element a radiating frequency of the second main conductive element 211, higher than f⁽¹⁾ if its difference with the frequency of the fundamental mode of the first conductive element is higher than a threshold value Δf. The determination of Δf is explained in detail further down in the description.

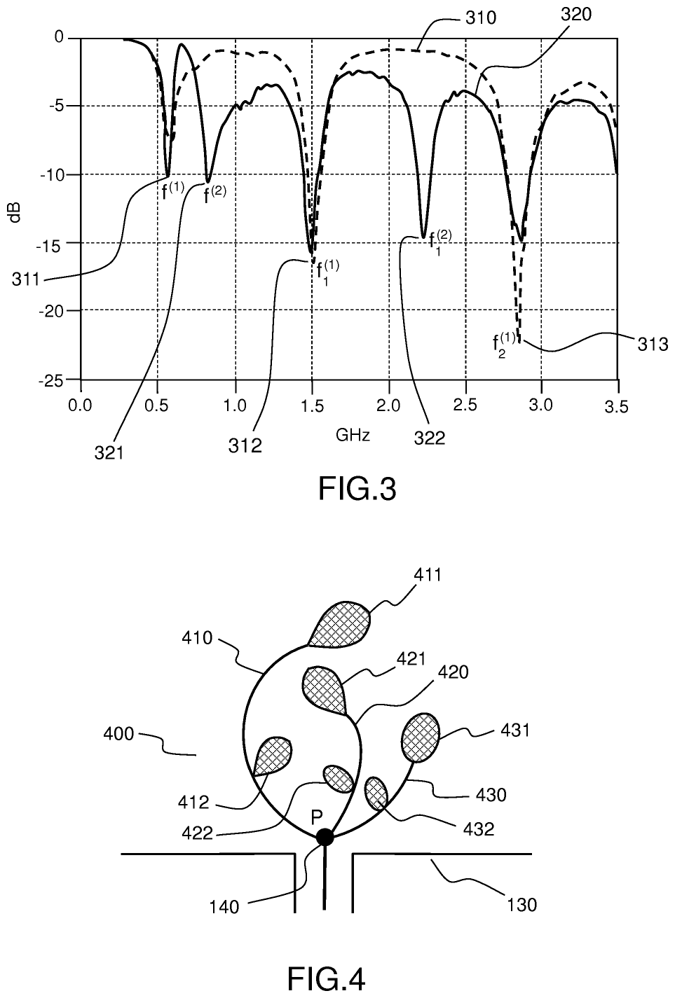

FIG. 3 illustrates the frequency responses of the antenna arrangement of FIG. 1 and of the antenna arrangement of FIG. 2.

Curve 310 represents the frequency response of the antenna arrangement of FIG. 1 (prior art). The abscise axis displays the values of the frequencies of the electromagnetic radiation and the ordinate axis the values of their matching level. Frequency f⁽¹⁾ (0.56 GHz, 311) is the first harmonic or fundamental mode of the electromagnetic radiation, frequency f₁⁽¹⁾ (1.50 GHz, 312) is its third harmonic or first higher mode and frequency f₂⁽¹⁾ (2.86 GHz, 313) is its fifth harmonic or second higher mode. These frequency values are tuned by using leaves 121, 122 that are connected to the trunk as displayed on FIG. 1.

Curve 320 represents the frequency response of the antenna arrangement of FIG. 2. Frequency f⁽²⁾ (0.85 GHz, 321) is the first harmonic or fundamental mode of electromagnetic radiation of the second main conductive element. Frequency f₁⁽²⁾ (2.34 GHz, 322) is its third harmonic or first higher mode. These frequency values are tuned by using leaves 221, 222 that are connected to the second trunk as displayed on FIG. 2. It is remarkable that the addition of the second main conductive element does not change the frequencies at which the first main conductive element resonates (f⁽¹⁾, f₁⁽¹⁾, f₂⁽¹⁾). This is because the second main conductive element is implanted at the feed point 140 that is common to the two main conductive elements and that is a Cold Spot for all resonating modes of the first and second main conductive elements.

FIG. 4 represents a first variant of an antenna arrangement with three trunks in an embodiment of the invention. On the figure, the antenna arrangement 400 represents an exemplary embodiment of the invention. It comprises three trunks 410, 420, 430 that connect at the feed line 140. Trunk 410 has two leaves 411, 412. Trunk 420 has two leaves 421, 422. Trunk 430 has two leaves 431, 432. As explained in relation to FIG. 2, connecting the two trunks 420, 430 to the feed line of trunk 410 allows designing an antenna arrangement that has three different fundamental resonating frequencies that may not be in a predetermined ratio as are the fundamental mode and the higher order modes of a single trunk. This increases significantly the number of options that are accessible to a designer of a multi-frequency antenna arrangement. If necessary, leaves 411, 412, 421, 422, 431, 432 are then positioned on the trunks to shift the resonating frequencies of the higher order modes of each trunk monopole antenna.

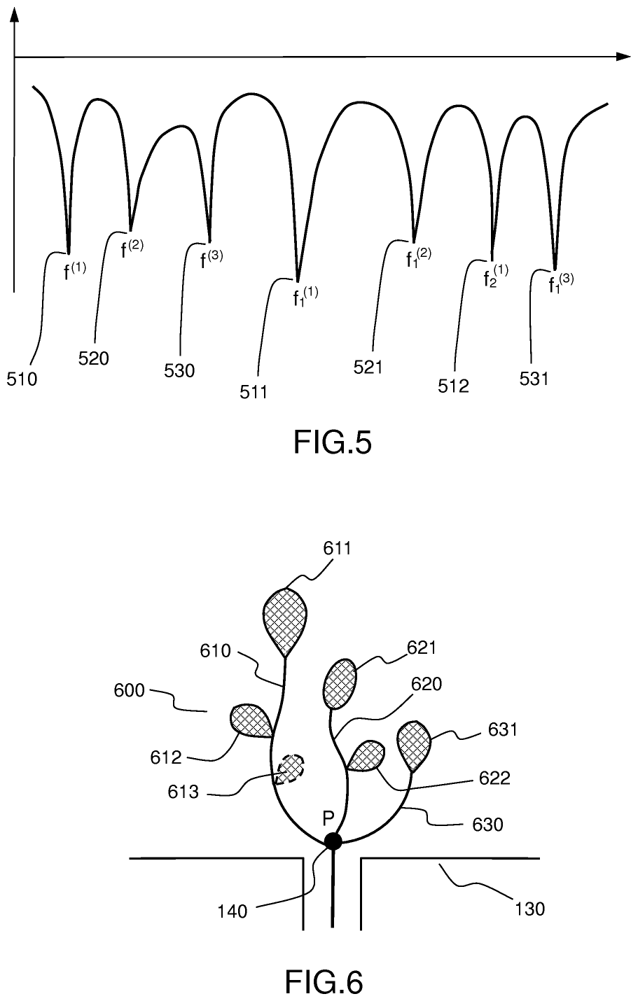

FIG. 5 illustrates the experimental frequency response of the antenna arrangement of FIG. 4.

Each of the trunks radiates at a fundamental mode f⁽¹⁾, 510, f⁽²⁾, 520, f⁽³⁾, 530. The first trunk also has a first order radiating mode f₁⁽¹⁾, 511 and a second order radiating mode f₂⁽¹⁾, 512. Likewise, the second trunk has a first order radiating mode f⁽²⁾, 521 and a second order radiating mode f⁽²⁾, (not represented on the figure because its value is higher than the right end of the abscissa) and the third trunk has a first order radiating mode f₁⁽³⁾, 531 and a second order radiating mode f₂⁽³) (not represented on the figure because its value is higher than the right end of the abscissa).

There are therefore nine different frequencies at which the antenna arrangement 400 radiates, seven of which are represented on the figure.

The respective electrical lengths of the trunks 410, 420 and 430 are:

[symbol]

_{e(λ}_{⁽¹⁾}₎⁽¹⁾=1/4(λ⁽¹⁾); [symbol] _{e(λ}_{⁽²⁾}₎⁽²⁾=1/4(λ⁽²⁾); [symbol] _{e(λ}_{⁽³⁾}₎⁽³⁾=1/4(λ⁽³⁾)

where λ⁽¹⁾=c/f⁽¹⁾; λ⁽²⁾=c/f⁽²⁾; λ⁽³⁾=c/f⁽³⁾.

The inequalities f⁽¹⁾<f⁽²⁾<f⁽³⁾ are verified.

FIG. 6 represents a second variant of an antenna arrangement with three trunks in an embodiment of the invention.

The antenna arrangement of FIG. 6 is a bit different from the one of FIG. 4. It also comprises three trunks, 610, 620, 630, that connect at the feed line 140. Trunk 610 has two leaves 611, 612. Trunk 620 has two leaves 621, 622. Trunk 630 has one leaf 631. Advantageously, it is possible to add a third leaf 613 to trunk 610 to increase the total electrical length of this conductive element. More generally, trunks 610, 620, 630 may have more or less leaves than represented on the figure.

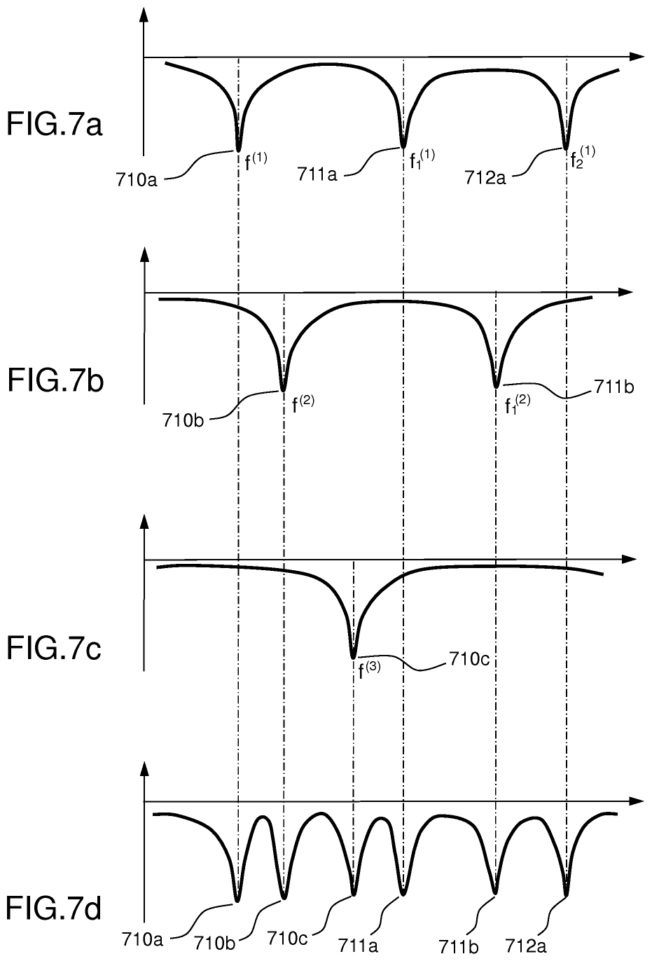

FIGS. 7a, 7b and 7c represent the individual frequency responses of each of the three trunks of the antenna arrangement of FIG. 6, while FIG. 7d represents the overall frequency response of the same antenna arrangement.

FIG. 7a represents the frequency response of the first trunk when it radiates as a stand-alone monopole antenna. Antenna element 610 has a fundamental radiating mode f⁽¹⁾ 710a, a first order mode f₁⁽¹⁾, 711a and a second order mode f₂⁽¹⁾ 712a.

FIG. 7b represents the frequency response of the second trunk when it radiates as a stand-alone monopole antenna. Antenna element 620 has a fundamental radiating mode f⁽²⁾, 710b and a first order mode f₁⁽²⁾, 711b.

FIG. 7c represents the frequency response of the third trunk when it radiates as a stand-alone monopole antenna. Antenna element 630 has a fundamental radiating mode f⁽³⁾, 710c.

Each of the trunks generates the same plurality of radiating modes, but due to the scale selected to represent the frequencies, only the fundamental and the two first order radiating modes of the first trunk are represented on the figures.

FIG. 7d represents the frequency response of the antenna arrangement that combines the three trunks 610, 620 and 630. Since the three trunks are connected at the feed line 140, that is a Cold Spot for all modes of the three trunks, the frequency response of the combination of the three trunks is the sum of the frequency responses of each individual monopole that is combined in the antenna arrangement.

The antenna arrangement will radiate at each of all six frequencies 710a, 710b, 710c, 711a, 711b and 712a.

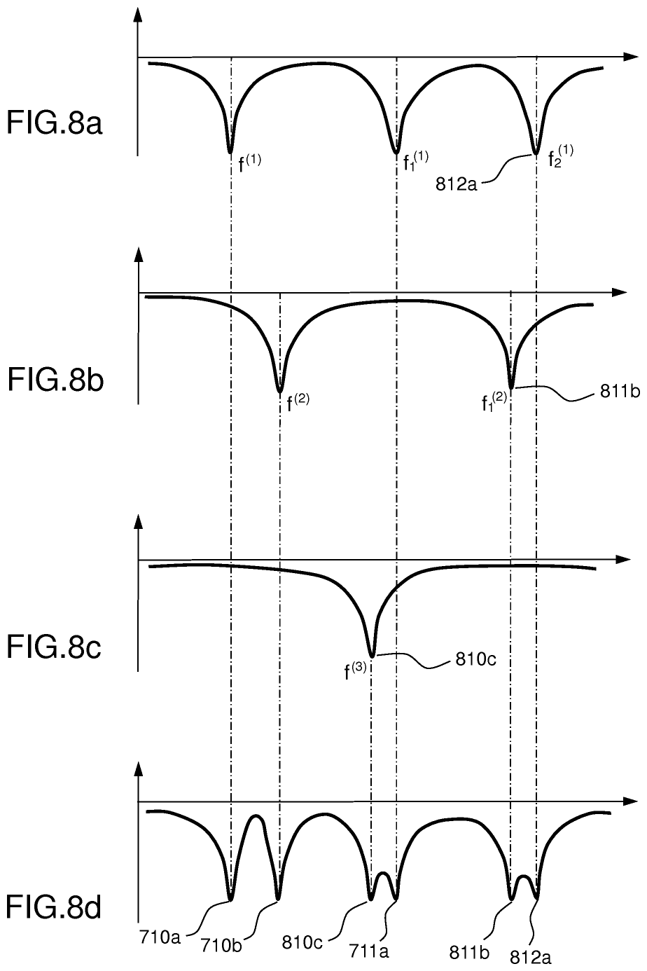

FIGS. 8a, 8b and 8c represent the individual frequency responses of three trunks of an antenna arrangement that have resonating frequencies that have been shifted relative to those of the antenna arrangement of FIG. 6. FIG. 8d represents the overall frequency response of the combination of the three trunks.

The frequency 710a of the fundamental mode of the first trunk 610 and the frequency 711a of the first order mode are the same as the ones of FIG. 7a, while the frequency 812a of the second order mode is advantageously shifted downwards relative to the value 712a of the frequency of the second order mode of FIG. 7a. This shift may be obtained either by a change of the position of the leaves 611, 612, their lengths, their orientations or their form factors, or by adding a third leaf, 613.

Likewise the frequency 710b of the fundamental mode of the second trunk 620 is unchanged, while the frequency 811b is shifted upwards relative to the value 711b of the first order mode of FIG. 7b. This shift may be obtained either by a change in position of the leaves 621, 622, their lengths, their orientations or their form factors.

The frequency 810c of the fundamental mode of the third trunk 630 of this embodiment is advantageously shifted upwards relative to the value 710c of the fundamental mode of FIG. 7c. This shift may be obtained either by a change in the length of the trunk 630, or by a change of the length of the leaf 631, its orientation or its form factor.

As displayed on FIG. 8d, the values of f₁⁽¹⁾ and f⁽³⁾ being close enough, a second order resonating filter is formed between trunks 610 and 630 at frequency f₁⁽¹⁾. The bandwidth at this frequency is enlarged by at least the difference between f₁⁽¹⁾ and f⁽³⁾. Likewise, the values of f₂⁽¹⁾ and f₁⁽²⁾ are close enough for a second order resonating filter to be formed between trunks 610 and 620 at frequency f₂⁽¹⁾.

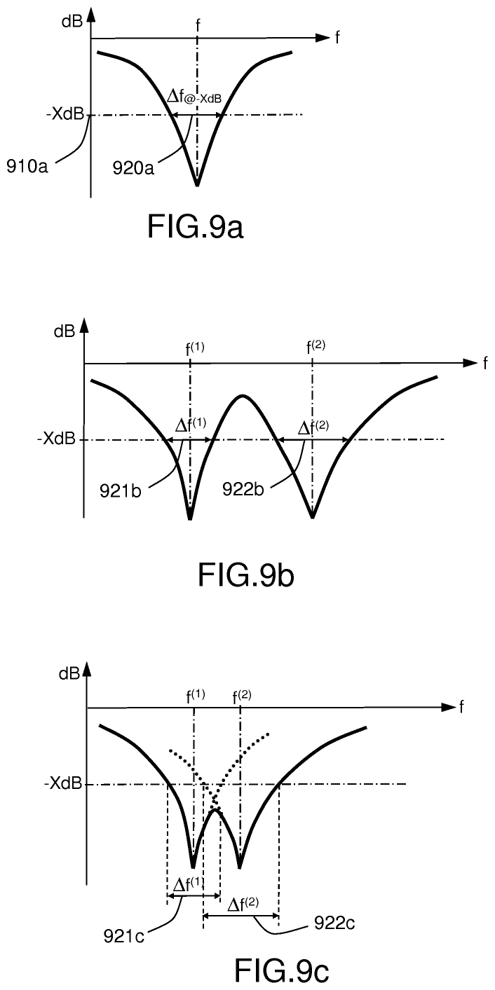

The meaning of “close” in relation to the distance between the frequencies of the trunks is discussed in details in relation to FIGS. 9a, 9b and 9c below.

FIG. 9a illustrates the calculation of the selectivity of a resonating structure at a given frequency and a given matching level, while FIG. 9b illustrates a combination of two frequency responses where the two resonating frequencies remain separate and FIG. 9c illustrates a combination of two frequency responses where the two resonating frequencies merge in an enlarged bandwidth.

For a specific frequency f, a target matching level −X dB, 910a is defined. For a matching impedance of the antenna of 50 Ohms, a matching level of −10 dB is customary. But other matching levels may be targeted, depending on the application, for instance −5 dB or −15 dB. The selectivity of the antenna σ(σ=Δf_{@-XdB}) 920a at this matching level is then defined as the difference between the two frequencies where the frequency response curve intersects the horizontal line −X dB.

For two frequencies f⁽¹⁾ and f⁽²⁾ we then define the quantity

Σ=(σ⁽¹⁾+σ⁽²⁾)/2

Thus Σ=(Δf_{@-XdB}⁽¹⁾+Δf_{@-XdB}⁽²⁾)/2

FIG. 9b represents a situation where f⁽²⁾−f⁽¹⁾>Σ. In this situation, the two frequencies are sufficiently separated to define two different resonating frequencies of the antenna arrangement, as evidenced on the figure itself, where the two segments 921b, representing Δf_{@-XdB}⁽¹⁾, and 922b, Δf_{@-XdB}⁽²⁾, do not overlap. If the second frequency is defined by a second trunk while the first frequency is defined by a first trunk, the combination of the two trunks will advantageously define a resonating structure with these two frequencies.

FIG. 9c represents a situation where f⁽²⁾−f⁽¹⁾<Σ. In this situation, the two frequencies are too close to define two different resonating frequencies of the antenna arrangement as evidenced on the figure where the two segments 921c, representing Δf_{@-XdB}⁽¹⁾, and 922c, Δf_{@-XdB}⁽²⁾, do not overlap. The two trunks of this configuration will advantageously define a second order resonating filter that will resonate at the first frequency and define an enlarged bandwidth around this first frequency.

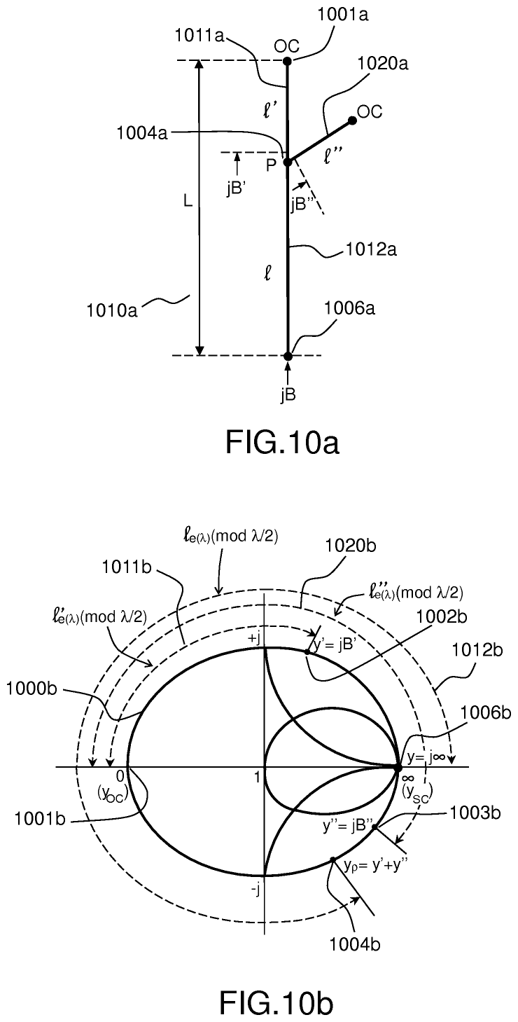

FIGS. 10a and 10b respectively illustrate an antenna arrangement with a trunk and a branch with position and dimension parameters and a Smith Chart that allows direct calculation of the values characterizing the radiating behaviour of the antenna arrangement as a function of the position and dimension parameters.

FIG. 10a represents the schematics of an antenna arrangement according to the invention, that has a first monopole antenna element 1010a that has a total physical length L=l+l′. This first antenna element is connected to the feed line of the antenna arrangement at point 140, 1006a and has a point that is an Open Circuit, 1001a. The two segments 1012a of length l and 1011a of length l′ are separated by a point P, 1004a. A second antenna element, 1020a, is another antenna element that is positioned at point P. It has a length l″ that extends from point P to an Open Circuit point. In this example, the second antenna element may be designated as a “branch” and not a “trunk”, since it is not directly electrically connected to the feed line at point 140, but at a different point, P. As described in European patent application referenced EP16306768.9, the position point P is selected to be at or near a position of a belly of current of one of higher order modes of the first resonating element 1010a, its exact position being calculated as explained below.

For a frequency f, corresponding to a wavelength λ=c/f, the following identities are verified:

L= [symbol] + [symbol] ′

[symbol]

= [symbol] _{e(λ)}×λ

[symbol]

′= [symbol] ′_{e(λ)}×λ

[symbol]

″= [symbol] ″_{e(λ)}×λ

Starting from the geometrical parameters defining the antenna arrangement, we can apply the identities that allow a calculation of the admittances seen from P that receives a current from a segment that starts from on OC:

for segment 1011a: Y′_{P}=j×B′( [symbol] ′) (Eq. 1)

for segment 1020a: Y′_{P}=j×B″( [symbol] ″) (Eq. 2)

Since segments 1011a and 1020a are connected in parallel at point P, 1004a, the following condition is verified:

Y_{P}=j×(B′( [symbol] ′)+B″( [symbol] ′)) (Eq. 3)

The admittance seen from the feed line point 140, 1006a is

Y₁₄₀=j×B( [symbol] , [symbol] ′, [symbol] ″) (Eq. 4)

Finally, for frequency f to be a resonating frequency of the combined antenna arrangement, a Short Circuit condition at this point 140 should be fulfilled at this frequency:

Y₁₄₀=j×∞ (Eq. 5)

These equations may be solved analytically, graphically using a Smith Chart, as explained below in relation to FIG. 10b, or using simulation tools such as CST™, HFSS™, Feko™ or Comsol™, or any other proprietary software.

Circle 1000b on FIG. 10b represents the imaginary part of the admittance. Equation 1 is represented graphically (Modulo λ/2, i.e. one full round on the Smith Chart of the figure) by the arc 1011b that joins the point of zero admittance (Open Circuit) 1001b to the point 1002b defined by Eq. 1. Equation 2 is represented graphically (Modulo λ/2) by the arc 1020b that joins point 1001b to point 1003b. Equation 3 defines point 1004b. Equation 5 defines point 1006b, that is the point of Short Circuit or infinite admittance.

Solving this equation allows solving the direct problem consisting in determining λ (and therefore f), knowing [symbol] , [symbol] ′ and [symbol] ″.

Conversely, as a solution to the inverse problem of determining the main parameters of an antenna arrangement of the type illustrated on FIG. 10a ( [symbol] , [symbol] ′ and [symbol] ″) to obtain a resonating frequency, one notes that the Smith Chart may be used to determine, for instance [symbol] by measuring clockwise (Modulo λ/2) the arc distance 1012b between points 1004b and 1006b.

Starting from a trunk, being a first resonating element having first proper resonating modes comprising a fundamental mode f⁽¹⁾ and higher order modes fⱼ⁽¹⁾ and adding a branch or a trunk being a second resonating element having second proper resonating modes comprising a fundamental mode f⁽²⁾ and higher order modes fₖ⁽²⁾ will form a combined antenna arrangement, having in general a new fundamental mode f* and higher order modes f*ₘ.

Depending on the context, in this specification, f⁽¹⁾, fⱼ⁽¹⁾, f⁽²⁾ and fₖ⁽²⁾ may be respectively denoted f, fⱼ, f′ and f′ₖ.

If the second resonating element is positioned at the feed line (P=140), the first proper modes of the first resonating element will advantageously not be affected, P being a Cold Spot for all modes of the first resonating element. Then, the second proper modes of the second resonating element (f⁽²⁾ and fₖ⁽²⁾) will add to the list of proper modes of the first resonating element f⁽¹⁾ and fⱼ⁽¹⁾, to form a combined list of resonating modes of the combined antenna arrangement. If f⁽²⁾≈f⁽¹⁾ or if there exists one or more j and k for which fₖ⁽²⁾≈fⱼ⁽¹⁾, then the bandwidth around this common value will be widened. The definition of how close the frequencies should be for this to happen is given in the description above in relation to FIGS. 9a, 9b and 9c.

If the second resonating element is positioned at a Cold Spot of a mode of the first resonating element, the resonating frequency of this mode will not be affected, but the frequencies of the other modes will be affected.

If the second resonating element is positioned at a location that is not a Cold Spot of a mode of the first resonating element, the resonating frequencies of all the modes of the first resonating element will be affected, as will be the modes of the second resonating element.

In the last two embodiments, it may be necessary to calculate the proper modes of the combined antenna arrangement, f*, f*ₘ. In the last described embodiment where the second resonating element is positioned at a location that is not a Cold Spot of one of the modes of the first resonating element, all proper modes need to be calculated. In embodiments where the second resonating element is positioned at a location that is a Cold Spot of one of the modes of the first resonating element, all the proper modes but one need to be calculated. The calculation may use a Smith Chart as explained above or a direct analytical computation or a simulation software.

In some circumstances, it is possible to analytically solve the inverse problem of selecting [symbol] , [symbol] ′ and [symbol] ″ to design an antenna arrangement of a defined resonating frequency. If we assume the segment of physical length [symbol] to be without loss, to be loaded by an admittance Y_{L} at an end and to have as characteristic admittance Y_{C}, the admittance Y_{IN} seen at the other end of the segment will be given by the following equation:

$${Y}_{IN} = {Y}_{C} \times \frac{{Y}_{L} + j \times {Y}_{C} \times t g ( β𝓁 )}{{Y}_{C} + j \times {Y}_{L} \times t g ( β𝓁 )} \qquad ( Eq . 6 )$$

where, when the propagation media is the ambient air, β=2π/λ or β=2π×f/c

Using the fact that Y_{L}=0 at both OC positions of segments 1011a and 1020a, and using Eq. 3 and Eq. 6, we can write the expression of the admittance at the feed line point 140, 1006a:

$${Y}_{140} = \frac{\begin{matrix}j \times {Y}_{C} \times ( tg ( \frac{2 π \times f}{c} \times 𝓁 ) + \\ tg ( \frac{2 π \times f}{c} \times {𝓁}^{′} ) + tg ( \frac{2 π \times f}{c} \times {𝓁}^{″} ) )\end{matrix}}{\begin{matrix}1 - ( tg ( \frac{2 π \times f}{c} \times {𝓁}^{′} ) + \\ tg ( \frac{2 π \times f}{c} \times {𝓁}^{″} ) ) \times tg ( \frac{2 π \times f}{c} \times 𝓁 )\end{matrix}} \qquad ( Eq . 7 )$$

Indeed, the admittance at the feed line point is a function of frequency f and of physical lengths [symbol] , [symbol] ′ and [symbol] ″:

Y₁₄₀(f, [symbol] , [symbol] ′, [symbol] ″)

If the resonating frequency of the antenna arrangement is f* (and λ*=c/f*), and we restrict [symbol] , [symbol] ′ and [symbol] ″ to be lower than λ*/4 (i.e. ( [symbol] , [symbol] ′, [symbol] ″)∈[0,λ*/4]³), we will generally be able to solve Y₁₄₀(f*, [symbol] , [symbol] ′, [symbol] ″)=∞ or 1/Y₁₄₀(f*, [symbol] , [symbol] ′, [symbol] ″)=0

We therefore need to have the denominator of Eq. 7 equal to zero (while its numerator is not null):

$$\frac{1}{tg ( \frac{2 π \times {f}^{*}}{c} \times 𝓁 )} = tg ( \frac{2 π \times {f}^{*}}{c} \times {𝓁}^{′} ) + tg ( \frac{2 π \times {f}^{*}}{c} \times {𝓁}^{″} ) \qquad ( Eq . 8 )$$

Solving for [symbol] , yields:

[symbol]

=c/4×f*−c/2π×f*−arctg(tg(2π×f*/c× [symbol] ″)+tg(2π×f*/c× [symbol] ″)) (Eq. 9)

The solutions [symbol] , [symbol] ′ and [symbol] ″ for a target resonating frequency f* therefore belong to a surface in a 2D space that is defined by Eq. 9. In other words, starting from a monopole antenna of physical length L, it is possible to determine couples of a position P and a length of a branch [symbol] ″ that will make it possible for the combined antenna arrangement to resonate at frequency f*.

In the case the specification of the antenna requires a plurality of resonating frequencies, the triplets ( [symbol] , [symbol] ′, [symbol] ″)∈[0,λ*/4]³ should satisfy Equation 8 for all target resonating frequencies f*,f*ₘ.

It may be that there exists no solution that satisfies all the constraints. In such a situation, the designer may relax the constraints, for instance by selecting a solution that minimizes a cost function, thus finding a relative optimum. It is also possible to look for solutions that do not belong to [0,λ/4]³, that will be higher order resonating modes of the antenna arrangement. It is also possible to add new branches as illustrated further down in the specification.

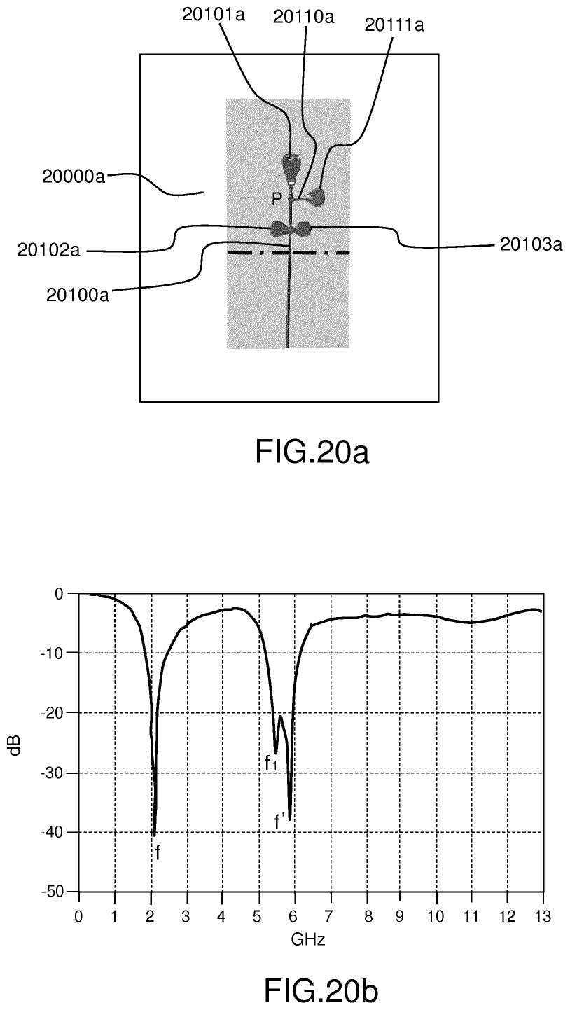

As already explained, the condition of orthogonality of the proper modes of a plurality of resonating elements that are connected together is only fulfilled when the resonating elements are all connected to the feed line 140, i.e. when all branches are indeed trunks. The design of the antenna is simpler but offers fewer degrees of freedom. Especially, when the specification of the antenna includes a plurality of resonating frequencies that are not higher order modes of a same fundamental mode, the number of trunks that it is possible to connect at the feed line is limited, especially when the antenna arrangement has to be inscribed in a 2D PCB, as will be exemplified further down in the description in relation to FIG. 20a. In such a case, it is advantageous to be able to use a branch located at a position that is not the feed line.

Using the calculations explained above, it is possible to find the values of [symbol] , [symbol] ′ and [symbol] ″ that will determine a group of frequencies f*, f*ₘ matching a specification of an antenna arrangement. The specification will generally also include specified bandwidths for each of the frequencies at a defined matching level and a defined selectivity. These calculations may be performed iteratively until all the specified frequencies are adjusted.

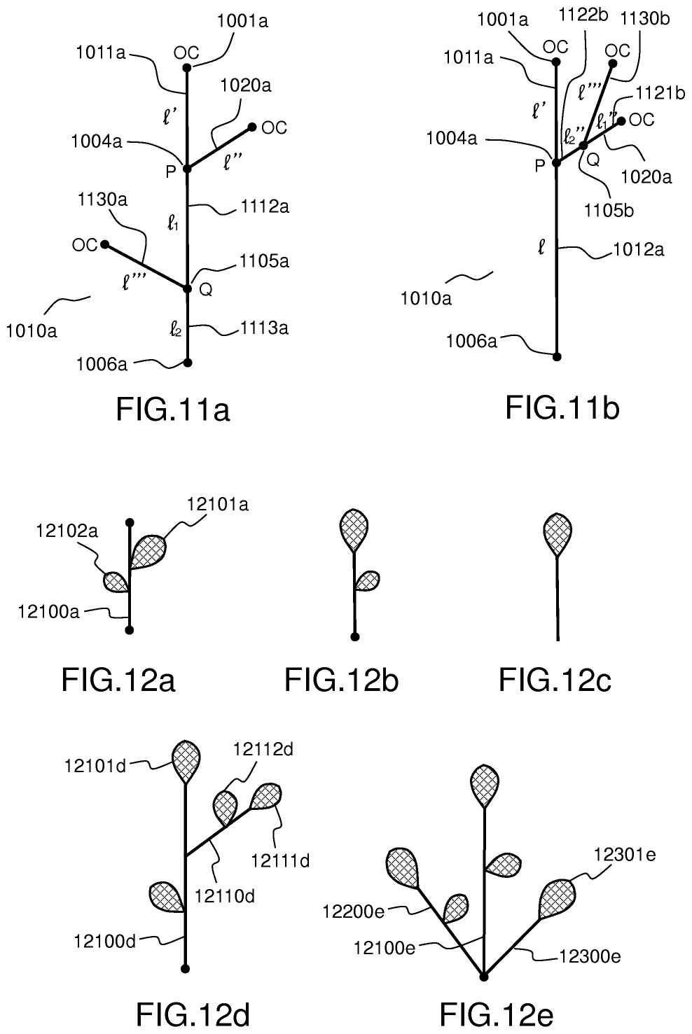

Also, it is possible to add a plurality of branches (second and third resonating elements) at different points on a same trunk, or to add a second branch (third resonating element) at a point defined on a first branch (or second resonating element), as now described in relation with FIGS. 11a and 11b.

FIGS. 11a and 11b respectively illustrate a first antenna arrangement with a trunk and two branches connected to the trunk and a second antenna arrangement with a trunk, a first branch connected to the trunk and a second branch connected to the first branch, both arrangements with their position and dimension parameters.

On FIG. 11a, a first resonating element 1010a similar to the one depicted on FIG. 10a under the same reference is segmented into three parts 1011a, 1112a and 1113a of respective physical lengths [symbol] ′, [symbol] ₁′, [symbol] ₂ by two points P, 1004a and Q 1105a. At point P, a second resonating element 1020a (or first branch), similar to the one depicted on FIG. 10a under the same reference is added to the trunk 1010a. This first branch has a physical length [symbol] ″. A third resonating element (or second branch) 1130a is added at point Q. This second branch has a physical length [symbol] ′″.

The same rules and equations similar to those explained in relation to FIGS. 10a and 10b will be used to define the relationships between the parameter values of the antenna arrangement:

where L= [symbol] ′+ [symbol] ₁+ [symbol] ₂

and [symbol] ′= [symbol] ′_{e(λ)}×λ

and [symbol] ″= [symbol] ″_{e(λ)}×λ

and [symbol] ′″= [symbol] ′″_{e(λ)}×λ

and [symbol] ₁= [symbol] _{1,e(λ)}×λ

and [symbol] ₂= [symbol] _{2,e(λ)}×λ

Equations 1 to 3 hold and are supplemented by:
the equation defining the admittance seen at the base of segment 1112a of length [symbol] ₁, that ends at point P:

Y_{1,Q}=j×B₁( [symbol] ₁, [symbol] ′, [symbol] ″) (Eq. 10)
the equation defining the admittance seen at the base of segment 1130a of length [symbol] ′″, that ends at an OC:

Y′″_{Q}=j×B′″( [symbol] ′″) (Eq. 11)
the equation defining the admittance seen at point Q from segments 1112a and 1130a that are connected in parallel at that point Q:

Y_{Q}=j×(B₁( [symbol] ₁, [symbol] ′, [symbol] ″)+B′″( [symbol] ′″)) (Eq. 12)
the equation defining the admittance seen at the feed line point 140

Y₁₄₀=j×B₂( [symbol] ₁, [symbol] ₂, [symbol] ′, [symbol] ′, [symbol] ′″) (Eq. 13)

Finally, the SC condition should be fulfilled for the defined frequency to be a resonating frequency:

Y₁₄₀=j×∞ (Eq. 14)

It is also possible to determine an analytical solution to the inverse problem to find relationships between the physical lengths parameters ( [symbol] ′, [symbol] ″, [symbol] ′″, [symbol] ₁, [symbol] ₂) of the antenna elements as explained in relation to FIGS. 10a and 10b, while the solution will be more complex and will be in a 5D space.

On FIG. 11b, is represented another variant where the first resonating element 1010a (or trunk) is now exactly configured as on FIG. 10a. The second resonating element (or first branch) 1020a of FIG. 10a that is connected to the first resonating element (or trunk) at point P, 1004a is now segmented in two portions 1121b and 1122b of respective lengths [symbol] ″₁ and [symbol] ″₂ separated by point Q, 1105b. At this point, a third resonating element 1130b (or second branch) is connected, that has an electric length [symbol] ′″.

Rules and equations similar to those explained in relation to FIG. 11a will be used to define the relationships between the parameter values of the antenna arrangement:

where L= [symbol] ′+

[symbol]

and [symbol] = [symbol] _{e(λ)}×λ

and [symbol] ′= [symbol] ′_{e(λ)}×λ

and [symbol] ′″= [symbol] ′″_{e(λ)}×λ

and [symbol] ″₁= [symbol] ″_{1,e(λ)}×λ

and [symbol] ″₂= [symbol] ″_{2,e(λ)}×λ

In this case, the following equation 15 will replace Equation 12:

Y_{Q}=j×(B₁″( [symbol] ′″₁)+B′″( [symbol] ′″)) (Eq. 15)

The following equations will replace Equation 4:

Y_{2,P}=j×B″₂( [symbol] ″₂, [symbol] ″₁, [symbol] ′″) (Eq. 16)

Y′_{P}=j×B′( [symbol] ′) (Eq. 17)

Y_{P}=Y_{2,P}+Y′_{P}=j×(B′( [symbol] ′)+B″₂( [symbol] ″₂, [symbol] ″₁, [symbol] ′″)) (Eq. 18)

Y₁₄₀=j×B( [symbol] , [symbol] ′, [symbol] ″₁, [symbol] ″₂, [symbol] ′″) (Eq. 19)

The calculation of the variables will be completed by solving the condition of resonance defined by Equation 14 (Y₁₄₀=j×∞).

It is also possible to determine an analytical solution to the inverse problem to find relationships between the physical lengths parameters ( [symbol] , [symbol] ′, [symbol] ′″, [symbol] ″₁, [symbol] ″₂) of the antenna elements as explained in relation to FIGS. 10a and 10b, while the solution will be more complex and will be in a 5D space.

It is possible to iterate the design of the antenna arrangement by adding other branches either on the trunk (or first resonating element) or on a branch previously positioned on the trunk or on a branch.

FIGS. 12a, 12b, 12c, 12d and 12e represent different embodiments of antenna arrangements according to the invention.

These figures represent trunks, branches together with leaves according to different embodiments. Leaves may be used to shift the resonating frequencies of some proper resonating modes of a trunk or a branch. The closer to a Hot Spot for a mode (fundamental or higher order) of a resonating structure it is located, the more the leaf will affect the frequency of this mode. The leaves may be located on the trunk itself (like leaves 12101a and 12102a on trunk 12100a on FIG. 12a, or like leaf 12101d on trunk 12100d on FIG. 12d, or like leaf 12301e on trunk 12300e on FIG. 12e, or like the leaves on trunks 12100e and 12200e on the same figure), on a branch (like leaves 12111d and 12112d on branch 12110d that connects to trunk 12100d on FIG. 12d).

Many variants of these configurations are possible, adding to the numerous possibilities offered by the invention to adjust the number and values of the resonating frequencies of an antenna arrangement and their bandwidths.

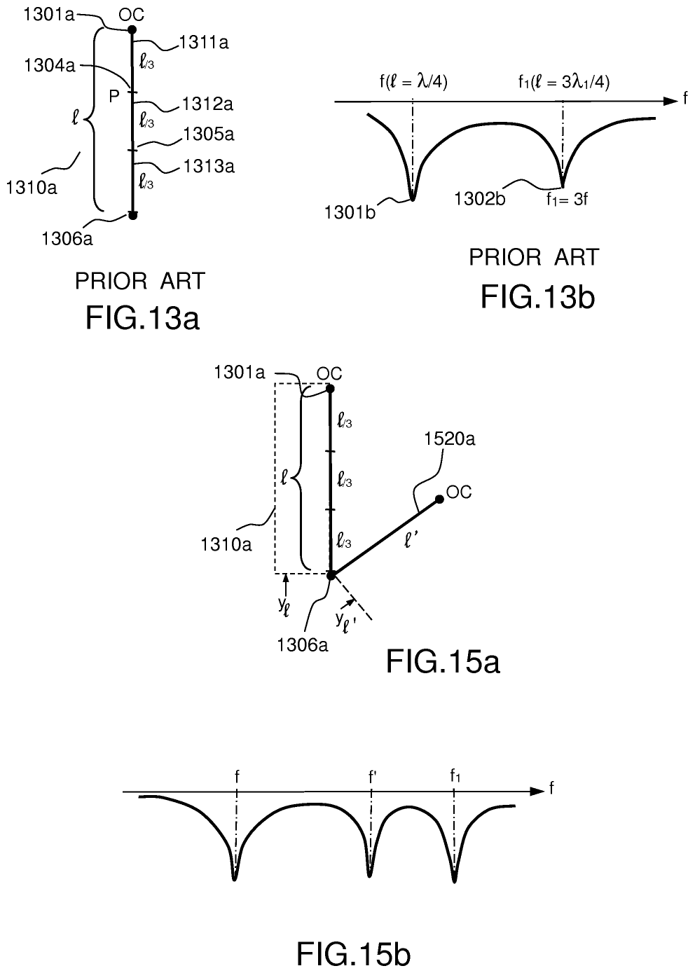

FIGS. 13a and 13b respectively represent a trunk antenna according to prior art and its frequency response.

As explained above, a monopole antenna element 1310a of physical length l will resonate at a fundamental mode defined by a frequency f=c/λ, 1301b (c being the speed of light in vacuum) or f =c/4l. The first higher order mode of this antenna element is defined by the third harmonic of this fundamental radiating frequency, that is f₁=3c/4l or f₁=3f, 1302b.

The bellies of current of electromagnetic radiation of this first higher order mode is located at the Cold Spots for this frequency, i.e. at one third of l (at point 1304a starting from the Open Circuit position 1301a at the top of the antenna element) and at the feed line 140 or 1306a. These four points 1301a, 1304a, 1305a and 1306a potentially determine three segments 1311a, 1312a and 1313a with a same physical length [symbol] .

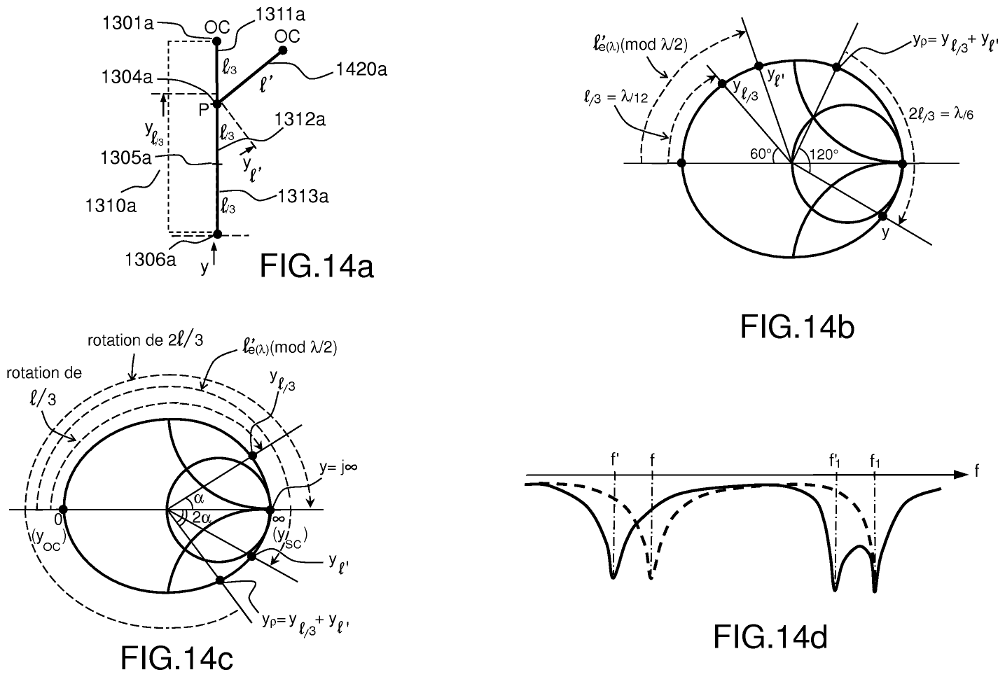

FIGS. 14a, 14b, 14c and 14d respectively represent a schematic of an antenna arrangement having a trunk and a branch with their position and dimension parameters, a Smith Chart for a first resonating frequency of the antenna, a Smith Chart for a second resonating frequency of the arrangement and the frequency responses of the trunk and the trunk with branch.

On FIG. 14a, is represented the trunk monopole antenna 1310a of FIG. 13a that is used as a first resonating element that is supplemented by at least a second resonating element to implement the invention. The same reference numerals designate the same elements. A second resonating element (or branch) 1420a of length l′ slightly higher than l/3 is added at point 1304a. Since this point is a Cold Spot for f₁=3f, the frequency of this resonating mode of the trunk is not changed by the addition of the second resonating element. But since it is not a Cold Spot for f, the frequency of this resonating mode is modified by the addition of the branch 1420a.

The Smith Chart of FIG. 14b allows calculating the value f′ of the new resonating frequency of the combined antenna arrangement comprising the trunk 1310a and the branch 1420a. The same equations as the ones presented in relation to FIG. 10b are applied to determine the value of f′ by first determining the admittance of segment 1311a, [symbol] , and of segment 1420a, [symbol] , then the combined admittance at point P, Y_{P} and finally the admittance Y₁₄₀ at point 1306a seen from this point. Since we have Y_{P}= [symbol] + [symbol] , it can be seen on the figure that Y is in the bottom half-plane when calculating Y₁₄₀ at frequency f and that the total electric length of the combined antenna arrangement is higher than 1/4(λ) at frequency f. The value of f′ is therefore lower than f.

f′ defines a new value of frequency of the fundamental resonating mode of the combined antenna arrangement. The antenna arrangement also has higher order modes. The frequency of the first higher mode f′₁ is a bit lower than f₁. By applying the rules defined above in relation with FIG. 9c, it is possible to determine l′ in such a way that f′₁ is close enough to f₁, to create an enlarged bandwidth under f₁.

The Smith Chart of FIG. 14c allows the calculation of f′₁ using the same equations as the ones indicated in relation with FIGS. 10b and 14b above.

FIG. 14d illustrates the frequency response of the trunk 1310a alone (curve 1410d) and of the combined antenna arrangement comprising the trunk 1310a and the branch 1420a (curve 1420d). The figure illustrates the benefit of the invention that results from an addition of a branch 1420a of length [symbol] ′ a bit higher than [symbol] ( [symbol] being the length of the trunk) at point P situated at a distance of [symbol] of the Open Circuit top of the trunk: on one hand the frequency of the fundamental mode is shifted, as would be the case by adding a leaf at point P; on the other hand, the bandwidth of the frequency of the first higher mode is enlarged. The length [symbol] ′ of branch 1420a is selected based on the specification of the antenna arrangement as explained in European patent application referenced EP16306768.9 and depends on the targeted shift in frequency and the targeted bandwidth resulting of the addition of the branch.

It is possible to select other geometrical parameters, for instance [symbol] < [symbol] , to match a different specification thanks to the invention.

FIGS. 15a and 15b respectively represent a schematic of an antenna arrangement having a trunk and a branch positioned at the feed connection with their dimension parameters and the frequency response of the antenna arrangement.

On FIG. 15a, is represented the trunk monopole antenna 1310a of FIG. 13a that is used as a first resonating element to implement the invention. The same reference numerals designate the same elements. A second resonating element (or trunk) 1520a of length l′ slightly higher than l/3 is added at point 1306a.

Since this point is a Cold Spot for all resonating modes of both the first resonating element and the second resonating element, the resonating modes of both resonating elements are also resonating modes of the antenna arrangement resulting from the combination of the two trunks, as is illustrated on FIG. 15b: f, f₁, being respectively the fundamental and the first higher order mode of the first resonating element 1310a and f′ being the fundamental mode of the second resonating element 1520a, the combined antenna arrangement will have three resonating frequencies f, f₁ and f′. In the case that is illustrated on the figure, f′ is far enough from f₁ to define two different resonating modes (three in total). l and l′ may also be selected so as to define an enlarged bandwidth under f₁.

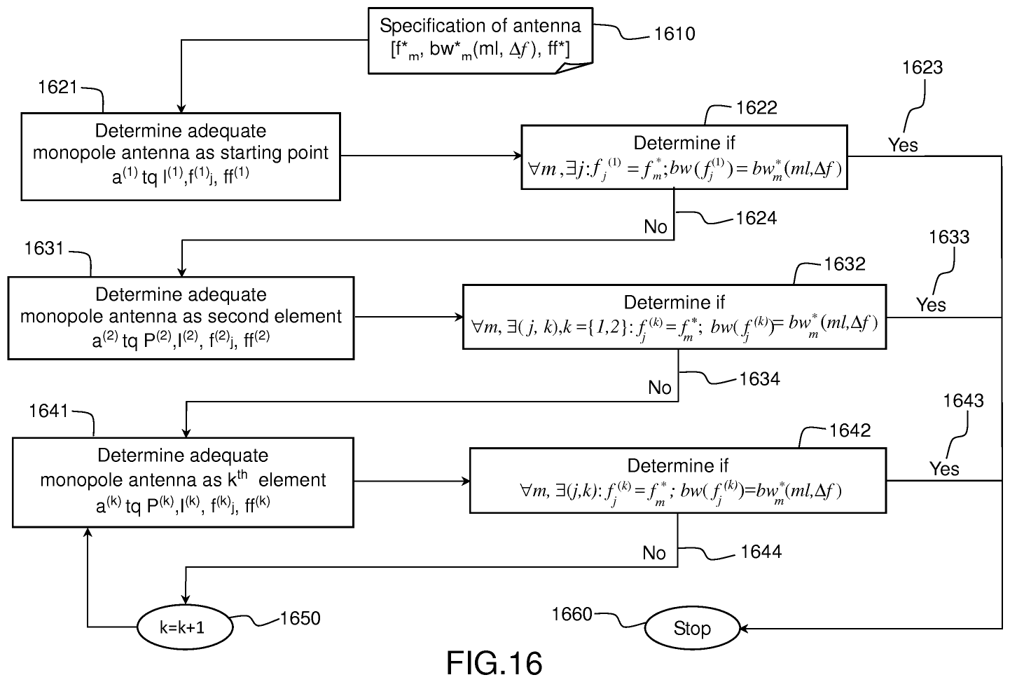

FIG. 16 represents a flow chart of a method to design multiband antenna arrangements according to the invention.

At a step 1610, the specification of the antenna is evaluated. The specification may be given in a form comprising a list of target resonating frequencies f*ₘ with corresponding bandwidths bw*ₘ, the bandwidths being defined for a matching level ml and a sensitivity Δf at this matching level. The matching level and the sensitivity may be the same for all target frequencies or they may differ from one frequency to another. The form factor ff* of the antenna arrangement may also be part of the specification, as well as the development cost and the production cost of the antenna arrangement, so as to obtain a compact antenna arrangement.

At a step 1621, a first antenna element a⁽¹⁾ is selected. It will have a resonating frequency above the lowest targeted resonating frequency f⁽¹⁾. This determines the length l⁽¹⁾ of the element. It may be that all the frequencies and bandwidths of the specification of the antenna exactly correspond to the parameters of this first element. The verification is simple for the values of the frequencies since the value of the frequency of the fundamental mode is f⁽¹⁾=c/4l⁽¹⁾ and the higher order modes should be f₁⁽¹⁾=3c/4l⁽¹⁾, f₂⁽¹⁾=5c/4l⁽¹⁾, etc. If some values do not match exactly, it is possible to modify its form factor ff⁽¹⁾ or to add one or more leaves to shift the frequencies of one or more of the modes. This may be done according to the teachings of European application referenced EP2016/306059.3 that discloses an antenna arrangement with leaves positioned on a trunk and a design method thereof. The determination of the shift in frequency that may be achieved using a leaf may be performed using abaci of the type disclosed in said application, simulation tools, or experimental verification. It may also be, that the bandwidths also match the specification. This is checked at a step 1622, either experimentally or by simulation. If all parameters of the specification are met (branch 1623), the process stops here (step 1660).

If not (branch 1624), a second resonating element a⁽²⁾ should be added at a step 1631. The second resonating element will be positioned at point P⁽²⁾ and will have a length [symbol] ⁽²⁾ that will determine a standalone fundamental resonating frequency f⁽²⁾. The values of P⁽²⁾ and [symbol] ⁽²⁾ will be selected to be able to fulfil a further portion of the specification, without regressing in the matching of the frequencies previously achieved. Also, the form factor ff⁽²⁾ of the second resonating element may be modified and/or leaves may be added to try and match the specification. One knows that adding a second resonating element without modifying the predefined resonating frequencies is only possible in principle when positioning the second resonating element at the feed line 140. But it may also be possible to select these values so as to shift one of the frequencies in a desired manner and/or to enlarge a bandwidth of a frequency previously determined, like illustrated on FIG. 14d and commented upon on the corresponding part of the specification. In any case, it may be necessary to check what is the impact of adding the second resonating element on the frequencies and bandwidths already adjusted at the first step. The determination is done by using abaci, simulation or experimental verification (step 1632). If positive (branch 1633), the process is ended (step 1660). If not (branch 1634), the process continues (step 1650).

A general formulation of the iterative method comprises steps 1641, 1642, 1643, 1644, 1650 and 1660:
At step 1641, for an antenna element a^{(k)}, its position P^{(k)}, its length l^{(k)} corresponding to a stand alone fundamental resonating frequency f^{(k)} and its form factor ff^{(k)} are set at initial values, based on the previous steps and the frequencies and bandwidths that are still to be adjusted;
At step 1642, a verification is performed, using analytical resolution when possible, abaci, simulation and/or experimental trials of the adjustment of the parameters of the combined antenna arrangement to the specification;
If the adaptation has been achieved in totality (branch 1643), the process is ended (step 1660);
If not (branch 1644), a new iteration is performed (k=k+1; step 1650), by adding a branch or a trunk.

One should note that in the course of adjusting some of the frequencies, new leaves may be added on a branch or a trunk, or a position of a leaf already in place may be changed, or its dimension or form factor.

The method of the invention advantageously offers a number of degrees of freedom to adapt the characteristics of an antenna arrangement to a defined specification: using trunks positioned at the feed line of the arrangement is the most straightforward solution, since it will not modify the resonating frequencies that have been previously adjusted. This orthogonality of the resonating modes of the successive antenna elements simplifies the design. This may come at the expense of an increased implementation cost, if the number of resonating frequencies in the specification is high, since the number of trunks in a 2D antenna design is quite limited. Therefore, adding branches will allow circumventing this limitation, allowing greater flexibility with a reduced cost.

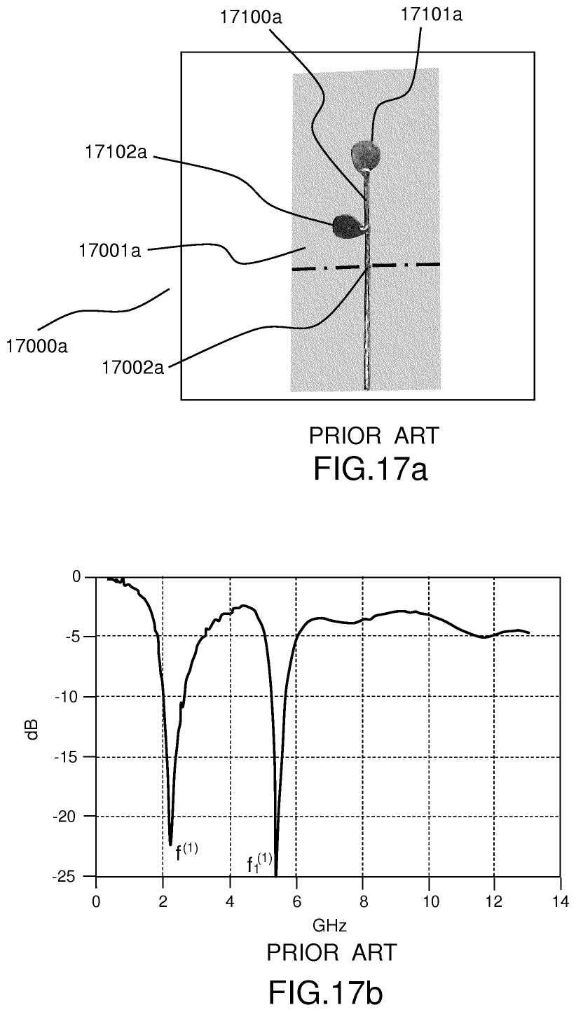

FIGS. 17a and 17b respectively represent an example of a 2D antenna arrangement and its frequency response according to the prior art.

FIG. 17a illustrates a 2D antenna arrangement 17000a according to the prior art that has a trunk 17100a, two leaves 17101a, 17102a on this trunk. The trunk is connected at the point 17002a to the feeding line. The trunk and leaves may be manufactured by a printing process on a paper substrate 17001a, but the substrate may also be rigid or flexible, as is the case for a polymer or ceramic substrate. The substrate may also be in any other non-conductive material. Printing may be performed by prior metallisation and further etching of the substrate, or by selective printing of the substrate. The ground plane may be implanted on the back face of the substrate by the same process.

FIG. 17b illustrates that this resonating structure has two resonating frequencies f⁽¹⁾ and f₁⁽¹⁾. In the example of the figure, we have f⁽¹⁾=2.33 GHz and f₁⁽¹⁾=5.45 GHz, both values being close to the two Wi-Fi bands.

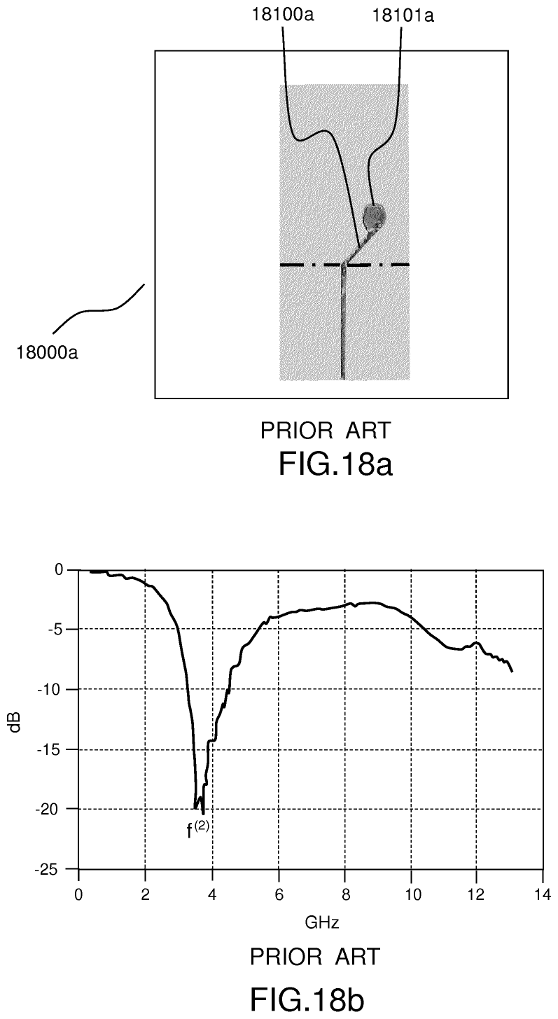

FIGS. 18a and 18b respectively represent another example of a 2D antenna arrangement and its frequency response according to the prior art.

FIG. 18a illustrates a 2D antenna arrangement 18000a that has a trunk 18100a and a leaf 18101a on this trunk, according to prior art. The same substrate, feed line arrangement, ground plane and manufacturing process as the ones explained in relation to the antenna arrangement 17000a may be used.

This antenna arrangement has a single resonating frequency f⁽²⁾ in the frequency band that is of interest to the designer. In the example illustrated on the figure, f⁽²⁾=3.66 GHz.

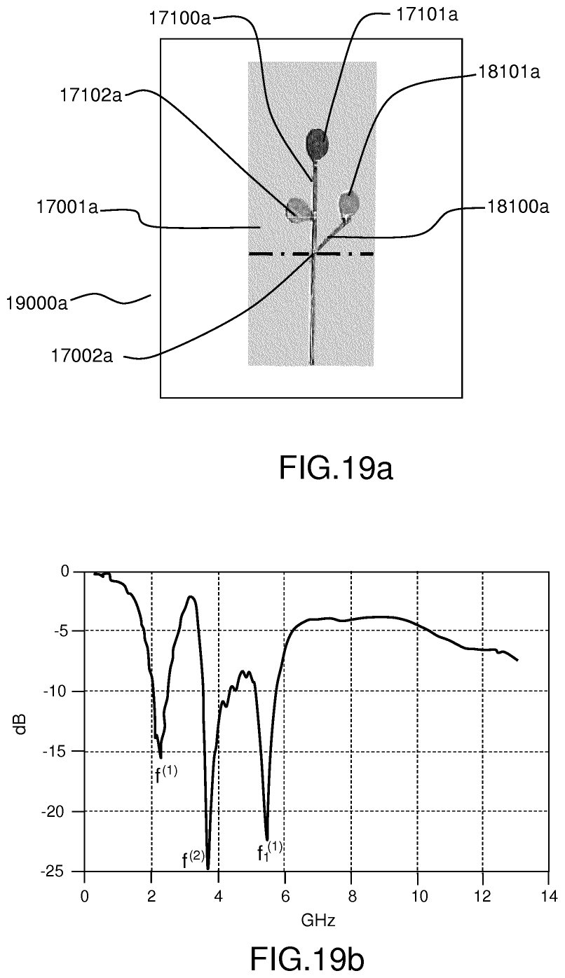

FIGS. 19a and 19b respectively represent an example of a 2D multiband antenna arrangement according to the invention and its frequency response.

FIG. 19a illustrates a 2D antenna arrangement 19000a that is a combination of the two resonating elements 17000a and 18000a. The combined antenna arrangement may be manufactured using the same components, materials and processes than for its two resonating elements.

Since the two resonating elements are connected at the feed line, the two resonating frequencies f⁽¹⁾ and f₁⁽¹⁾ of the antenna arrangement 17000a are preserved, while the single resonating frequency f⁽²⁾ of the antenna arrangement 18000a is shifted apparently upwards to 3.76 GHz as illustrated on FIG. 19b, while this shift is not significant because it is due to the fact that the two antenna arrangements are not exactly identical.

According to the invention, in this embodiment, the number of resonating modes of the resonating structure 17000a has been advantageously increased from two to three by adding a trunk at the feed line of the first resonating structure.

FIGS. 20a and 20b respectively represent another example of a 2D multiband antenna arrangement according to the invention and its frequency response.

On FIG. 20a is illustrated an antenna arrangement 20000a comprising a trunk 20100a to which three leaves 20101a, 20102a and 20103a are connected and a branch 20110a, to which a leaf 20111a is connected. This antenna arrangement may be manufactured using the same components, materials and processes than for the antenna arrangements of FIGS. 17a, 18a and 19a.

FIG. 20b represents the frequency response of the combined antenna arrangement. The three frequencies represented on the figure have the following values:
f=2.12 GHz
f₁=5.45 GHz
f′=5.89 GHz

The bandwidths at a matching level of −10 dB are 0.62 GHz around f (from 1.86 to 2.48 GHz or 29%) and 1.04 GHz around f₁ (from 5.21 to 6.25 GHz or 18%).

The two examples illustrate the numerous benefits of the invention that can be used to increase the number of resonating frequencies and the bandwidth, by locating additional resonating elements (trunks/branches) at the feed line or at other points, thus giving more flexibility to the antenna designer.

The invention may also be applied to dipole antennas. A dipole antenna is a two poles antenna where the two poles are excited by a differential generator. The two poles of the dipole antenna each operate with stationary regimes which have the same behavior. The two pole antennas each have a structure with a trunk, one or more branches and one or more leaves. In some embodiments of the invention, the two structures are symmetrical.

The examples disclosed in this specification are therefore only illustrative of some embodiments of the invention. They do not in any manner limit the scope of said invention which is defined by the appended claims.

1. An antenna arrangement comprising:
a first main conductive element configured to resonate above a first frequency defining a first fundamental mode of a first electromagnetic radiation;
at least a second main conductive element:
configured to radiate above a second frequency defining a second fundamental mode of a second electromagnetic radiation; and
having a feed connection located at or near a position on the first main conductive element that is defined as a function of positions of anti-nodes of current of harmonics of the first electromagnetic radiation;
wherein the antenna arrangement has a number of resonating modes that are higher than a number of resonating modes of the first main conductive element.

2. The antenna arrangement of claim 1, wherein the feed connection of the second main conductive element is located at a feed line of the first main conductive element.

3. The antenna arrangement of claim 2, wherein at least a difference between a second given frequency of one of a fundamental mode or a higher order mode of the second electromagnetic radiation and a first given frequency of one of a fundamental mode or a higher order mode of the first electromagnetic radiation is higher than half the sum of the electromagnetic selectivities of the second and first main conductive elements respectively at the second and first given frequencies, said electromagnetic selectivities being defined at a given matching level.

4. The antenna arrangement of claim 1, further comprising one or more first secondary conductive elements located at or near one or more positions defined on the first main conductive element as a function of positions of nodes of current of electromagnetic radiation of selected resonating modes of the first frequency.

5. The antenna arrangement of claim 1, wherein the at least second main conductive element comprises one or more second secondary conductive elements located at or near one or more positions defined on the second main conductive element as a function of positions of nodes of current of selected resonating modes of the second frequency.

6. The antenna arrangement of claim 1, wherein the second frequency is defined as having at least a resonating mode at which the second main conductive element forms a resonating structure of an order higher than one with parts of the antenna arrangement at a frequency of one of the selected resonating modes of the first frequency.

7. The antenna arrangement of claim 6, wherein the resonating structure of an order higher than one is matched at or above a predefined level across a bandwidth defined around the frequency of the one of the selected resonating modes of the first frequency.

8. The antenna arrangement of claim 7, wherein the bandwidth is equal to or larger than a predefined percentage value of the frequency of the one of the selected resonating modes of the first frequency.

9. The antenna arrangement of claim 7, wherein the antenna arrangement is matched across the bandwidth surrounding the frequency of the one of the selected resonating modes of the first frequency at a level equal to or greater than an absolute predefined value.

10. The antenna arrangement of claim 1, further comprising at least a third main conductive element having a feed connection located at or near a position on one of the first or second main conductive elements that is defined as a function of positions of bellies of current of selected resonating modes of the first or second frequencies, said third main conductive element being configured to form with at least parts of the antenna arrangement a resonating structure of an order higher than one at a frequency of one of the selected resonating modes of the first or second frequencies.

11. The antenna arrangement of claim 1, wherein one or more of the main conductive elements are a metallic ribbon and/or a metallic wire.

12. The antenna arrangement of claim 1, wherein one or more of the main conductive elements have one of a 2D or 3D compact form factor.

13. The antenna arrangement of claim 12, deposited by a metallization process on a non-conductive substrate layered with one of a polymer, a ceramic or a paper substrate.

14. The antenna arrangement of claim 1, tuned to radiate in two or more frequency bands, comprising one or more of an ISM band, a Wi-Fi band, a Bluetooth band, a 3G band, a LTE band, a GNSS band or a 5G band.

15. A method of designing an antenna arrangement comprising:
defining a geometry of a first main conductive element to resonate above a first frequency defining a first fundamental mode of a first electromagnetic radiation;
defining a geometry of a second main conductive element to resonate above a second frequency defining a second fundamental mode of a second electromagnetic radiation;
forming a feed connection of the at least a second main conductive element located at or near a position on the first main conductive element that is defined as a function of positions of anti-nodes of current of harmonics of the first electromagnetic radiation;
wherein the antenna arrangement has a number of resonating modes that is higher than a number of resonating modes of the first main conductive element.

16. The method of claim 15, wherein one or more main conductive elements of a defined length are iteratively added at defined positions to a pre-designed main conductive element so as to match a specification of the antenna arrangement comprising a list of predefined frequencies.

17. The method of claim 16, wherein the one or more main conductive elements that are added to match the specification of the antenna arrangement are further defined to match a specified bandwidth for at least one or more of the frequencies in the list of frequencies.

18. The method of claim 15, wherein the one or more main conductive elements that are added to match a specification are further defined to match a form factor of the antenna arrangement.
